(19) United States
(12) Patent Application Publication
(10) Pub. No.: US 2022/0414714 A1
(43) Pub. Date: Dec. 29, 2022

(54) Content Monetization and Development

(71) Applicant: Jonathan Bannon Maher, Ridgewood, NJ (US)

(72) Inventor: Jonathan Bannon Maher, Ridgewood, NJ (US)

(21) Appl. No.: 16/624,194

(22) PCT Filed: Jun. 19, 2018
(86) PCT No.: PCT/US18/38369

§ 371 Date: Dec. 18, 2019

Related U.S. Application Data
(60) Provisional application No. 62/522,659, filed on Jun. 20, 2017.

(51) Int. Cl. G06Q 30/02

(52) U.S. Cl. CPC G06Q 30/0269; G06Q 30/0276

(57) ABSTRACT

Systems, methods, apparatuses, and computer programs encoded on a computer storage medium, allow for matching advertisements with content, with advertisement and content formats including text, image, audio, video, and animation, by means which may include expected demographic of content audience, content words, and visitor locations, and may provide the option to the advertiser to review a listing of the individual content that was matched for presentation of the advertisement, where the advertiser may disable presentation for selected content, as well as add presentation for additional content, and set bids on individual content, allowing content publishers to provide advertisers an unprecedented level of targeting, as well as more relevant content if producing content supporting desired advertiser targeting, all while providing the content audience more relevant advertisements.

### TECHNICAL FIELD

Embodiments of the invention relate to the field of content monetization and development.

### REFERENCE TO RELATED DOCUMENTS

This application is provided the benefit and priority date of United States Patent and Trademark Office provisional patent application No. 62/522,659, filed Jun. 20 2017 by inventor Jonathan Bannon Maher, which is incorporated herein in its entirety.

### BACKGROUND

This section is intended to introduce the reader to various aspects of the art that may be related to various aspects of the present techniques, which are described and or claimed. This discussion is believed to be helpful in providing the reader with background information to facilitate a better understanding of the various aspects of the present disclosure. Accordingly, it is understood that these statements are to be read in this light, and not a citation of prior any art.

There several current methods for targeting advertisements, including the overwhelmingly untargeted method of print and online news media, where a category is selected, the overwhelmingly untargeted method of television and radio networks, where a category or show is selected, those of search engines, which display advertisements relevant to the keywords of the search, and those of social networks, which allow advertisers to target advertisements to user profile demographics. Countless content producers, such as news organizations, have in recent years been driven to financial distress or bankruptcy, as a result of being unable to offer advertisers either the active targeting of search engines, or the passive demographic targeting of social networks.

### BRIEF DESCRIPTION OF THE ILLUSTRATIONS

Illustrations are presented by way of example, and not by way of limitation, in the figures of the accompanying drawings, and embodiments may not contain all components, may contain additional components, and may contain functionally similar components.

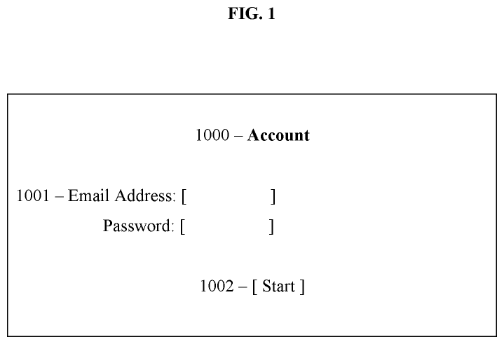

FIG. 1 is an embodiment of an example of a screen allowing a user to sign in to the system.

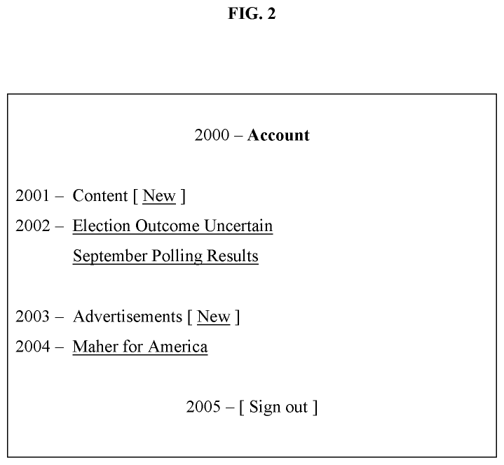

FIG. 2 is an embodiment of an example of a screen providing account information with a link to add new content, a list of created content, a link to add a new advertisement, and a list of created advertisements.

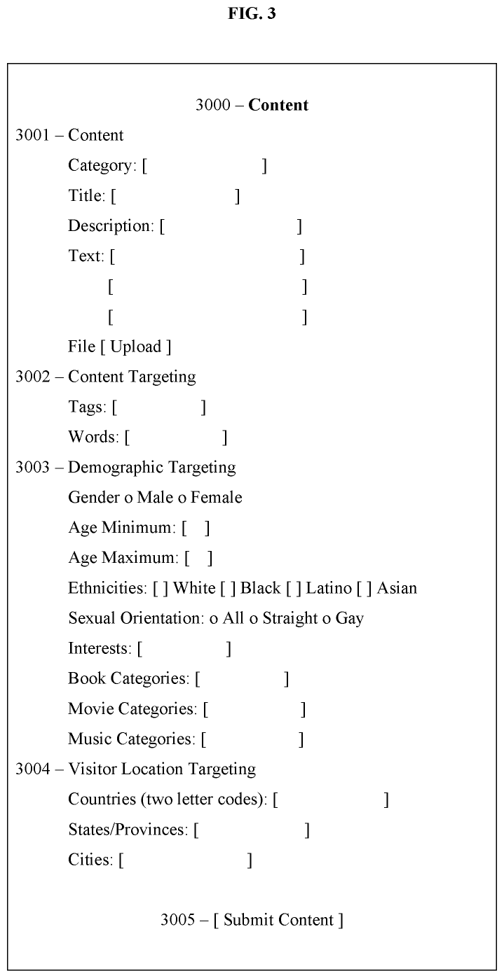

FIG. 3 is an embodiment of an example of a screen allowing a user to submit content to the system and specify targeting factors including expected audience demographics.

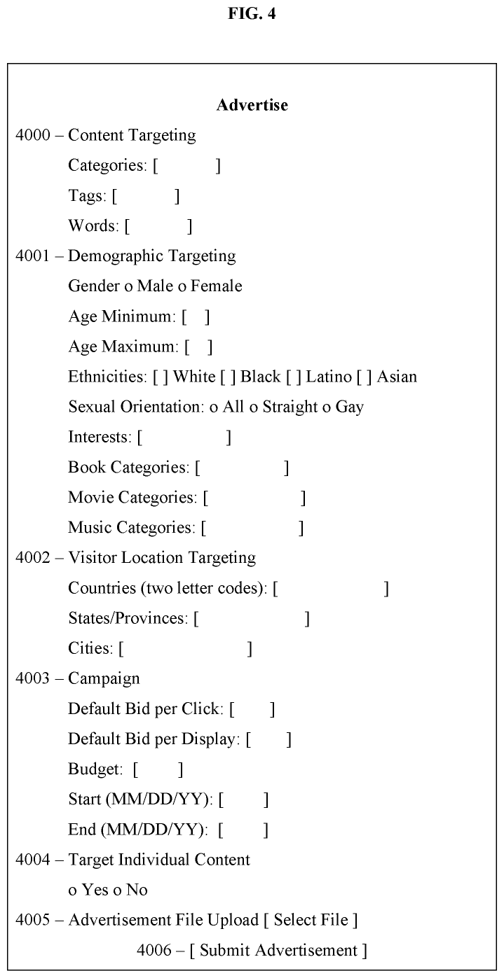

FIG. 4 is an embodiment of an example of a screen displaying the form to submit an advertisement with targeting of content based on factors including expected audience demographics.

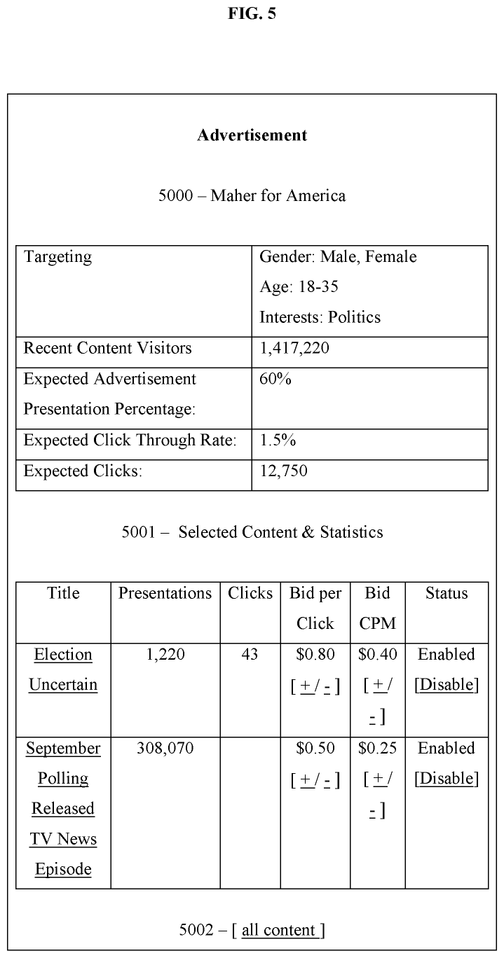

FIG. 5 is an embodiment of an example of a screen displaying a user created advertisement with aggregate performance statistics, specified targeting, and corresponding individual content along with a bid and performance statistics.

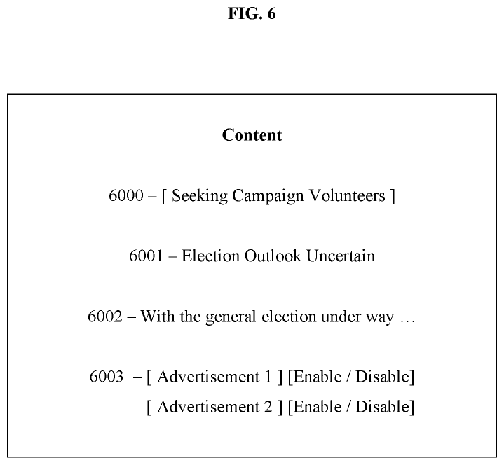

FIG. 6 is an embodiment of an example of a screen displaying content with an advertisement, including the ability for a logged in user to enable or disable display of their advertisements on the content.

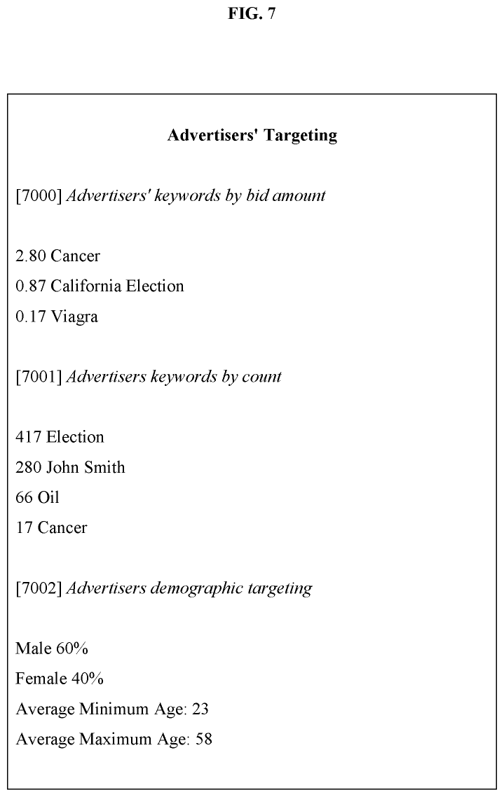

FIG. 7 is an embodiment of an example of a screen displaying information including demographics the advertisers on the platform are currently targeting, and the amounts they are willing to pay to for content matching that targeting.

### DETAILED DESCRIPTION

It is understood that, as in any engineering or design project, the development of any actual implementation will include numerous implementation specific decisions made to achieve the developers' specific goals, such as compliance with business related and system related constraints, which may vary from one implementation to another. It is understood that such a development effort might be complex and time consuming, but is nevertheless a routine undertaking of design, fabrication, and manufacture for those skilled in the art having the benefit of this disclosure. The disclosed steps may be read as prefaced by “In some embodiments, including one complete embodiment,”, may be executed or performed in other orders or sequences, and are not limited to the order and sequence shown and described, which are provided to enable ease in constructing an embodiment, and along with each components of each step, may be removed, modified, combined, or rearranged, and other steps and or step components may be added, without departing from the scope of this disclosure and or invention. Although embodiments of the invention have been described and illustrated in the disclosed implementations, it is understood that the present disclosed subject matter, including apparatuses, methods, specification, and illustrations, has been made only by way of example, not by way of limitation, and the methods and apparatuses may be used in other systems, and that numerous changes and optimizations in the details of implementation of the invention and or embodiment are made without such modifications departing from the spirit and scope of this disclosure and or embodiments of the invention. Although the disclosure has been shown and described with respect to one or more embodiments, features of the disclosed embodiments can be combined and rearranged in various ways, and changes including equivalent alterations, substitutions, modifications, and additional efficiencies will of course occur to someone of ordinary skill in the art without departing from the spirit and scope of this disclosure and or invention. In particular regard to the various functions performed by the described components, the terms used to describe such components are intended to correspond, unless otherwise indicated, to any component which performs the specified function of the described component, or is functionally equivalent to the described component, even though not structurally equivalent to the disclosed structure which performs the function in the implementations described in this disclosure. In addition, while a particular feature of the disclosure may have been provided with respect to only one of several embodiments, such feature may be combined with one or more other features of other embodiments as may be desired and advantageous for any given or particular application. In some instances, well-known circuits, structures and techniques have not been shown in detail in order not to obscure the understanding of this disclosure. Articles in this disclosure such as “a” “an” and “the” may allow for both singular and plural forms. Verbs in this disclosure such as “is” may be read as “may be”. Conjunctions in this disclosure such as “or” as used herein may be interpreted as inclusive or meaning any one or any combination, where “A, B or C” means “any of the following: A; B; C; A and B; A and C; B and C; A, B and C”. Relational terms in this disclosure, for example first and second, top and bottom, left and right, are to distinguish one entity or action from another, and may not necessarily require or imply a relationship, or order between, such entities or actions. The disclosure includes the best mode contemplated by the inventor, a completely described specific embodiment, along with optional components and alternative embodiments to best suit the implementer, measurements in imperial and metric units to support universal understanding, and dramatically exceeds claims support requirements and enablement requirements by allowing for selection and or construction of the required components to be carried out easily, quickly, and routinely by persons of ordinary skill in the art, who are provided the additional benefit of utilizing readily available commodity components whenever possible. The present disclosure includes material protected by copyrights, and the owner of the copyrights hereby reserves all rights, but with authorization for publication as required by government patent offices. Various embodiments of the present invention may provide all, some or none of the disclosed technical advantages.

The computer code descriptions disclosed, in order to provide comprehensive enabling disclosure, rather than utilizing flow charts, which according to Patent Cooperation Treaty 11.11a are prohibited from containing “text matter, except a single word or words, when absolutely indispensable, such as . . . a few short catchwords indispensable for understanding”, are provided in a text only format where the number of arrows preceding a line indicate logical block level, semicolons indicate a new segment of a logical block, and periods indicate the closure of one or more logical blocks. It is understood that any computer code representations in this disclosure are merely illustrative, rather than restrictive. While code may be written in nearly any computer language, including Java and C++, the illustrative computer code descriptions were derived from code written the Python language, which may be run through the Python interpreter, with appropriate supportive libraries, which at the time of disclosure, may run on nearly any computer, for example one with an Intel or AMD processor, running a current version of Linux, Windows, or Mac OS. All code components may read as if prefaced by “In some embodiments, including one complete embodiment,”. In some embodiments, functionality may be modified, rearranged, excluded, and added. To provide more fundamental computer system details, in some embodiments, the functionality associated with the disclosed computer code descriptions may be referred to as a script, module, software, software application, or code, and can be written in any form of language, including compiled, interpreted, declarative, or procedural, able to be deployed in any form suitable for use in a computing environment, including as an independent or integrated program, module, component, or subroutine, for execution by the computer system, implemented on one or more independent or integrated computers, utilizing a central processing unit in the form of one or more general or special purpose microprocessors, in conjunction with digital electronic circuitry, which may include special purpose logic circuitry such as a field programmable gate array or application specific integrated circuit, with the computer controlled by and operatively coupled to tangibly embodied software and or firmware, which may include code that creates an environment for code execution, including individual or combined use of processor firmware, a protocol stack, a database management system, and an operating system, where such software and or firmware may exist in one or more parts in memory on one or more computers, and is encoded on one or more tangible non transitory software carriers, such as individual or combined use of a random or serial access device or substrate, a semiconductor memory device, transient or persistent random access memory, a magnetic, magnetic optical, or optical disk, or encoded on an artificially generated transmitted signal, for example, optical, electrical, or electromagnetic, transmitted using a sending and a receiving apparatus, where the interaction between the user and the software may be implemented by operatively coupling, to the local implementing computer, or a local computer connected to one or more remote computers through a local or wide area network, a display device which may implement fluid crystals or light emitting diodes, a keyboard, and a pointing device.

The inventor retains absolutely no liability for any implementation of this invention, and the invention is implemented exclusively at the risk and liability of the implementer.

In some embodiments, including one complete embodiment, unprecedented demographic advertisement targeting of an unregistered audience is provided, where content and advertisements may be in formats including text, image, audio, video, and animation, and where content is tagged with demographics of the expected audience, allowing advertisements to target a combination of demographics, content keywords, and visitor location, where when an advertisement is created, all available content is scanned for a match with the desired demographic criteria, matching content is selected for the advertisement, where the advertiser may for maximum control optionally disable presentation on individual and or groups of content, as well as add presentation to items or groups of content, and set bids on individual content and or content groups, therefore providing unprecedented targeting by offering both the active targeting of search engines, which provides advertisements to individuals actively seeking information, and the passive targeting of social networks, by targeting audience demographic, therefore offering unprecedented targeting exceeding that offered by search engines, social networks, news outlets, radio stations, and television networks, while additionally providing maximum transparency and verification of advertisement placement, because unlike social networks which for privacy reasons can't reasonably allow an advertiser to review everyone's profile who's been served an advertisement, there is no privacy issue with presenting the individual content where the advertisement has been presented and the number of times a presentation resulted in a click, and therefore publishers are provided increased advertising rates through unprecedented targeting, users more relevant and interesting advertisements, advertisers more relevant content if publishers produce content supporting desired advertiser targeting, and potentially providing a full reversal of adopting media outlets declining financial condition, and a restoration of the reporting resources necessary to the security of a free people.

The system is designed to allow for both a platform that allows content publishers and advertisers to sign up to have content matched with advertisements, as well as for content publishers to implement it independently for their own exclusive use directly with their advertisers.

In some embodiments, including one complete embodiment, create data store structures to hold information. In some embodiments, including one complete embodiment, data structures are created in a suitable data store, for example where the data store is a relational database management system and data store structures are tables, by performing actions comprising:
create a data store structure for accounts, with fields including an auto incrementing integer primary key, a record creation timestamp, a username, and a password.
create a data store structure for sessions, with fields including a record creation timestamp, a session ID, and an account ID.
create a data store structure for publishers, with fields including an auto incrementing integer primary key, a record creation timestamp, an associated account ID, a name, a domain name, and a content index URL.
create a data store structure for advertisements, with fields including an auto incrementing integer primary key, a record creation timestamp, an associated account ID, an advertisement title, advertisement text, an uploaded file, the uploaded file name, a link to advertisers content to send the a user to, content, category, sub category, demographic fields including minimum and maximum age, sexual orientations, ethnicities, interests, countries, whether or not the advertisement has been indexed against content, whether or not its active, the default bid price per click, and the default bid price per impression, the total budget, and the start and end dates of presentation.
create a data store structure for content, with fields including an auto incrementing integer primary key, a record creation timestamp, an associated account ID, an associated publisher ID, the title, author, content, keyword tags, category, sub category, demographic fields including minimum and maximum age, gender, sexual orientations, ethnicities, interests, countries, a file, and a file name.
create a data store structure for content words, with fields including an associated content ID, and the word.
create a data store structure for content matched to advertisements, with fields including an associated advertisement ID, an associated content ID, whether or not advertisement presentation is enabled for the content, whether or not the advertiser individually selected the content, the bid per click, and the bid per presentation.
create a data store structure for locations associated with IP addresses, with fields including the IP address, the associated latitude, longitude, country, state or province, and city.
create a data store table for content presentations, with fields of the content ID, a record creation timestamp, and the IP address or other identifier for the individual audience member.
create a data store structure for advertisement clicks with fields of a record creation timestamp, advertisement ID, content ID, and the IP address or other unique identifier of the visitor.

In some embodiments, when the system is integrated with an existing data store, adjustments may be made to existing data structures to support the disclosed data structures and functionality.

In some embodiments, including one complete embodiment, create the software code to support the functionality of the system. In some embodiments, including one complete embodiment, the advertisement is inserted into the content being presented to users, by means which may include serving the advertisement file to the publisher who inserts it into the stream being presented to users, where the server is designed to allow advertisements to be presented within content including text, image, audio, video, and animation, as well as in native desktop and mobile applications, where the method of communicating with the server, and integrating the advertisements, is customized to the computer language and or requirements of the application. In some embodiments, including one complete embodiment, functionality is provided to the user, including the ability to insert, select, update, and delete data for each of the data tables, through either the application server and user interface, or through the user interface of the data management software. In some embodiments, including one complete embodiment, during the presentation of content, its presentation is recorded, and an advertisement is selected for presentation from those matched to the content, as well as optionally retrieving the geographic location of the audience member and restricting the advertisement served to one of without location targeting or one where the audience member is within the bounds of the specified target location, recording the presentation of the advertisement, and if the advertisement is clickable and clicked, recording the click of the advertisement and redirecting the user to the advertiser's designated location.

In some embodiments, including one complete embodiment, in reference to FIG. 1, an example user interface is presented that allows the user to sign in or create an account by entering and email address 1000 and password 1001 then pressing the start button 1002.

In some embodiments, including one complete embodiment, in reference to FIG. 2, an example screen is presented having a title 2000, providing a link to add new content 2001, providing a list by title of all recorded content 2002, providing a link to a screen to add a new advertisement 2003, a list of advertisements linked by title 2004, and a link to sign out 2005.

In some embodiments, including one complete embodiment, in reference to FIG. 3, an example user interface is provided to add and edit content while specifying expected audience demographic information, where the screen provides the title of the organization offering this platform 3000, fields to input the content including title, contents, category, and a file upload field to allows the upload of a content file if applicable, which may be in formats including text, image, audio, video, and animation 3001, fields for content targeting by advertisers including tags and words 3002, fields to specify demographic targeting, by gender, minimum age, maximum age, sexual orientation, ethnicities, interests, book categories, music categories, and movie categories 3003, fields to specify visitor location targeting by country, state or province, and city 3004, and submit button 3005 which when pressed saves the content to the server to then be stored and matched with advertisements.

In some embodiments, including one complete embodiment, in reference to FIG. 4, an example user interface is provided to allow advertisers to create an advertisement and target it to specific content, providing fields to specify targeting of content by categories, tags, and words 4000, fields to specify demographic targeting by attributes including gender, minimum age, maximum age, sexual orientation, ethnicities, interests, book categories, music categories, and movie categories 4001, fields to specify visitor location targeting by country, state or province, city, or other means of location targeting including postal code 4002, fields to specify campaign start date, end date, and default bid per click, and bid per presentation, and optionally a budget 4003, a checkbox indicating whether or not to target individual content 4004, a file upload field allowing the upload of an advertisement file, which may be in formats including text, image, audio, video, and animation 4005, and a submit button 4006 which saves the advertisement to the server to be stored and matched with content so that the advertiser can enable and disable display on selected content, and so that the system can run the advertisement

In some embodiments, including one complete embodiment, in reference to FIG. 5, an example user interface presents a list of content selected for the advertisement, and to allow for advertisers to optionally target individual content, where when restricting the list of content presented to those targeted for the advertisement, may provide the advertisement title, targeting, actual and expected aggregate performance statistics including the visitors to the selected content in the last 30 days, the percent of the time the advertisement is expected to be presented based on competing bids, the average click through rate if applicable of the targeted content, and the total expected clicks 5000, a listing of individual content with performance statistics that has been targeted for the advertisement, including presentations and clicks, display of the bid amount with the ability to increase and decrease the individual bid, as well as a button or link for enabling and disabling presentation within the content 5001, and a link to all content in the system for advertisers to search through content and enable presentation of the advertisement within additional content 5002.

In some embodiments, including one complete embodiment, a screen presenting content in the data store is made available, where the display may include a list of all content titles with a link to the individual content.

In some embodiments, including one complete embodiment, in reference to FIG. 6, an example of the display of individual content is provided, where the display includes an advertisement 6000, the title of the content 6001, the body of the content 6002, a list of any advertisements by the signed in user with the option to enable or disable the presentation of each advertisement with that content 6003.

In some embodiments, including one complete embodiment, in reference to FIG. 7, an example is presented of a screen provided to an administrator, to see what demographics the advertisers on the platform are currently targeting, and the amounts they are willing to pay to for content matching that targeting, to provide real time feedback to content producers about what content is most profitable to produce, including a list of advertisers keywords in descending order of bid 7000, a list of advertisers keywords in descending order of count 7001, and a list of advertisers targeted demographics by percentage 7002.

In some embodiments, including one complete embodiment, the code to provide a user interface to the system, and respond to requests, provides functionality comprising:
import a data management library and initialize a connection to a data store containing the previously disclosed data structures;
create a function to handle all server get requests;
   initialize a variable to hold the server response;
   if the requested action is to start a new session, in reference to example FIG. 1, return a screen allowing for a user to create a session by means which may include submitting an email address, username, or phone number and password;
   if the requested action is to display the users account, in reference to example FIG. 2, return a screen providing a list of the user's content, a link to a form to add content, a list of the user's advertisements, and a link to a form to add a new advertisement, and the option to sign out;
   if the requested action is to add or edit content, in reference to example FIG. 3, generate the content submission form, and display each form field including those that allow for content entry and targeting, as provided for in the previously disclosed corresponding data structures, including age minimum, age maximum, gender, ethnicity, sexual orientation, interests, etc.;
   if the requested action is to add or edit an advertisement, in reference to example FIG. 4, generate the advertisement submission form and display each form field including those that allow for content targeting, as provided for in the previously disclosed corresponding data structures, including age minimum, age maximum, gender, ethnicity, sexual orientation, interests, etc.;
   if the request is to return to an advertisement to a logged in user that user created, in reference to example FIG. 5, return the specified targeting for the advertisement, retrieve through data store queries and calculations the specified aggregate performance statistics, including percent of time advertisement is expected to be presented based on competing advertisers bids, average click through rate, expected clicks, display a list of content where presentation has been either enabled or disabled along with the option to enable and disable display, and the bids, display statistics, and clicks for individual content with the option to increase and decrease the bids, and a link to a list of content which may be presented as a result of a search to select further content for presentation of the advertisement;
   if the requested action is to display a list of content, display to the user a list of all user retrievable content by retrieving from the data store specified content fields including title;
   if specific content was requested, in reference to example FIG. 6, parse from the request the content identifier, retrieve the content from the data store, display that content to the user, record the presentation of the content to content presentations table in the data store, and if the user is logged in, list any advertisements associated with the account, with a link to enable or disable the advertisement with the content, and record that the content was presented;
   if the requested action is to display a list of advertiser targeting, in reference to example FIG. 7, return aggregate statistics including demographics the advertisers on the platform are currently targeting, and the amounts they are willing to pay to for content matching that targeting, including a list of advertisers' keywords in descending order of bid, a list of advertisers' keywords in descending order of count, and a list of advertisers targeted demographics by percentage.
   if the requested action is to present an advertisement, based on a advertisement ID previously generated by a post to the server, retrieve the advertisement from the data store, record that the advertisement was presented to the data store table holding advertisement presentations, optionally including for billing purposes whether or not it was targeted to specified content and or the bid, and return the advertisement, including if applicable a header specifying the content type of the advertisement, which may include text, image, audio, video, or animation;
   if the requested action is to redirect a user who has selected an advertisement, parse from the requesting URL the content ID and advertisement ID, then retrieve from the data store the advertisement's redirect location, record the visitor's IP address or unique identifier, to not bill more than one click per visitor, and return or redirect the visitor to the advertisers specified location;
create a function to respond to all server post requests;
   create variables holding the posted data including the posted action;
   if the action is to start a session, check if the provided email address, username, or phone number is in the data store, and if not create an account, and if it is, verify the password is correct for the account with the provided email address, if a new account was created, or an existing account with a matching password was found, create and associate with the account a session ID and store it to the user interface or user interface software to include with requests;
   if the post includes a session ID, retrieve the account ID associated with the session from the data store sessions table;
   if the action is to submit content, record the users account ID, and the content including all submitted fields and files to the corresponding data store structure;
   if the action is to submit an advertisement, record the users account ID, and the advertisement including all submitted fields and files to the corresponding data store structure, and insert the advertisement ID into the Advertisement Locations table;
   if the request is to retrieve an appropriate advertisement, take the posted data, and check if the publisher ID and content ID exist in the data store, and if not parse the posted content, including targeting information, and save it to the data store so it can be associated with advertisements, then check if the specified content ID has specific advertisements targeted to it, and if so select one to provide, by means which may include randomly selecting among the highest bidding advertisements, or selecting a random advertisement, and return the advertisement or an identifier that can be used to retrieve the identified advertisement;
   if the request is to enable or disable presentation of advertisement with content, record the association to the advertisement content data store structure;
   if the request is to increase or decrease the bid of an advertisement associated with content, record to the bid change to the advertisement content data store structure;
   if the request is to sign out, disassociate the session ID or expire the session from the user interface client;

In some embodiments, there may be a policy stating that advertisements found to be abusive in content or targeting will be disabled, for example, targeting content about a specific individual or organization with negative advertisements about that person or organization.

In some embodiments, including one complete embodiment, add content along with demographics to the data store. In some embodiments, including one complete embodiment, content is added and the content that is tagged, may be in any format, including text, image, audio, video, and animation. If the content is not text, a description of the content may be saved for targeting, such as a transcript of the audio. In some embodiments, including one complete embodiment, content with associated demographics is added to the data store in the corresponding table through the data store's included management interface, with the content demographics including but not limited to those in the previously disclosed data structure: expected minimum and maximum age, gender, location, sexual orientation, and content keywords, interest keywords, category, sub category. For example, it's reasonable to assume content discussing prostate cancer will be reviewed by older males interested in prostate cancer information, thus allowing it to be tagged with attributed of male and 40-80, with targeting of the words “prostate” and “cancer”, thus allowing for prostate cancer drug manufacturers upon submitting targeting criteria to have their advertisement set to present with that content, who will pay immensely more than for simple category based targeting, and who may be able to use the platform to target multiple advertising mediums all at once, including online and broadcast. The demographic tagging of content, and advertiser selection and deselection of content, may in some cases seem somewhat tedious or time consuming, but it's not expensive, as it can be performed by any modestly intelligent person including an intern or contractor. Content producers and advertisers who have a problem with that level of individualized targeting have the option of continuing to utilize less effective and less profitable targeting.

In some embodiments, the demographic data is embedded in the content, and the content is posted to the server to retrieve a matched advertisement, through software providing functionality comprising:
initialize a variable to hold the content being presented including related information such as demographic targeting;
include the script that posts the content to the server then inserts a targeted advertisement;
specify the demographic targeting criteria;
create a place holder for the advertisement;
identify the beginning of the content and present the content to the user;
identify the end of the content;
post the content and targeting information to the server, retrieve a matched advertisement, and insert it into the advertisement placeholder.

In some embodiments, a server side script continuously or periodically runs that retrieves the content from the publisher along with its demographics, where the script provides functionality comprising:
import a data store access library and initialize a variable to hold the data store connection;
run the script on a continuous loop;
   establish a connection to the data store if none has been established or the connection was lost;
   retrieve publishers content index addresses from the data store;
   iterate through each publisher, retrieve the content index, and check each content ID to see if it exists in the data store, or if its update timestamp is newer than the content in the data store for that content ID, and if either condition is true, retrieve the content, parse it, and save it to the data store content table, including overwriting the record for that ID if it already exists;
   pause program execution for a moment to not drain publisher server resources.

In some embodiments, demographic data embedded in content is sent to the server through client side code.

In some embodiments, including one complete embodiment, write a script that continuously or periodically indexes any unindexed content words, and matches advertisements to content utilizing content demographics and advertisement specified targeting. In some embodiments, including one complete embodiment, a script is executed to continuously run in the background, adding individual words appearing in the content or the content description to a data structure containing content IDs and words, so that content can be targeted where certain words appear, and additionally any advertisement has any specified demographics searched for in content tagged with those demographics, and if the content demographics and words match those specified in the advertisement, an entry is created in Content Advertisements data store structure linking the Advertisement ID with the Content ID, so that advertisement is presented with the matching content, with the software providing functionality comprising:
import the data store library and initialize a connection to the data store containing the previously disclosed data structures;
continuously run in the background to index all content and match advertisements to content;
create variable to hold whether or not unindexed content records were found, and the index of the current record;
loop while records are found;
   select the record ID and the Content text from Content records that haven't been indexed;
   if there aren't records, set records found to false to end the loop, but if records were found, proceed;
      create an array of each unique word in the content text, and insert each into a data store structure storing individual content words for targeting, with the Content ID and the word, then update the record as indexed;
      check if the content contains tags indicating the demographic content hasn't been parsed from the content, if such tags exist, parse the demographic data and update the content record;
      create variable to hold whether or not unindexed advertisement records were found, and the index of the current record;
   match content to advertisements by retrieving unindexed advertisements, then retrieving the content that has demographics that match the advertisement, record each matching content ID, then if the advertisement includes word targeting, select the content IDs that contain that word, from the content word table, and recording any content IDs that match both content and word targeting to the advertisement content table.

When new advertisements are added to the system, an administrator can review the targeting saved with the advertisement in the data store, and search for and manually associate any content relevant to the requested targeting that hasn't been tagged with that targeting, in order to ensure maximum relevant reach.

In some embodiments, including one complete embodiment, write a script to be included in the content to retrieve and insert a matching advertisement and optionally send the content with demographics to the server. In some embodiments, including one complete embodiment, client side code such as JavaScript is embedded in the webpage, and allows various types of advertisements to be dynamically inserted, such as text, images, audio, video, or animation, and allows the content of the page to be posted to the server with embedded demographics in case the content hasn't already been indexed, and may prevent advertisements from being presented and counted when crawled by a search engine for indexing purposes, providing functionality comprising:
post the content to the server, and read the generated advertisement ID, where posting of the content allows applications to integrate an advertisement when content can't be otherwise accessed by the server.
retrieve and insert into the advertisement placeholder specified in the display, the advertisement to display and its associated link, by utilizing the previously retrieved advertisement ID.

In some embodiments, including one complete embodiment, offer unprecedented targeting to advertisers, and advertisement relevance to users. In some embodiments, including one complete embodiment, once the system has been built, and the content providers have integrated the advertisements, advertisers can be offered unprecedented targeting and additional targeted content, publishers can increase advertising rates, audiences can see more relevant and interesting advertisements, and in the case of news organizations, recapture lost revenues to restore the reporting resources necessary to the security of a free people.

1. A system for targeted advertising, comprising:
content and advertisements in formats including but not limited to text, image, audio, video, and animation;
associating audience demographic and or expected audience demographic information with said content;
associating said advertisement with targeted audience demographic information;
matching said advertisements to said content based on said demographic targeting of said advertisement and actual or expected demographics of said content audience;

2. claim 1 further comprising:
providing the ability to enable or disable presentation of said advertisement on individual content.

3. claim 1 further comprising:
providing the ability to set the bid of said advertisement presented with individual content.

4. A system for content development, comprising:
displaying current advertisers requested content targeting, individually and or in aggregate, to inform the development of profitable content.
